(19) United States
(12) Patent Application Publication
(10) Pub. No.: US 2008/0079567 A1
(43) Pub. Date: Apr. 3, 2008

(54) WIRELESS PROTECTION SYSTEM

(76) Inventor: Robert Poor, Philadelphia, PA (US)

Correspondence Address: FISH & RICHARDSON PC, P.O. BOX 1022, MINNEAPOLIS, MN, 55440-1022, US

(21) Appl. No.: 11/836,023

(22) Filed: Aug. 8, 2007

Related U.S. Application Data
(63) Continuation of application No. 60/836,225, filed on Aug. 8, 2006.

(51) Int. Cl. G08B 21/00

(52) U.S. Cl. 340/540

(57) ABSTRACT

A wireless protection system includes a plurality of wireless units. A plurality of the units are each configured to monitor a characteristic of at least one other unit, to detect an exception condition associated with a monitored unit based on the monitored characteristic, and to send an alert message to a plurality of the units in response to detecting the exception condition.

### CROSS-REFERENCE TO RELATED APPLICATIONS

This application claims priority to U.S. Application Ser. No. 60/836,225, filed on Aug. 8, 2006, incorporated herein by reference.

### BACKGROUND

This invention relates to wireless protection systems.

Many stores and warehouses use Electronic Article Surveillance (EAS) systems to protect inventory from theft. A typical EAS system uses passive security tags attached to inventory or other assets, and one or more interrogators to detect the proximity of security tags. The interrogators are normally installed at the entrances and exits of the area to be protected. When an interrogator detects the proximity of a security tag, an alarm is triggered.

### SUMMARY

In one aspect, in general, a wireless protection system includes a plurality of wireless units. Each of a plurality of the units are configured to monitor a characteristic of at least one other unit, to detect an exception condition associated with a monitored unit based on the monitored characteristic, and to send an alert message to a plurality of the units in response to detecting the exception condition.

Aspects can include one or more of the following features.

The alert message is transmitted from a unit that detected the exception condition to a unit that did not detect the exception condition.

The alert message is transmitted over links of a network among the units, and the monitored characteristic comprises a characteristic of a link to the monitored unit.

Each of the plurality of units is configured to monitor a characteristic of at least one other unit.

Each of the plurality of units is monitored by at least one other unit.

Monitoring a characteristic of at least one other unit comprises receiving a radio signal from the unit.

The exception condition associated with the unit comprises a change in the nature of a signature of the radio signal.

The change in the nature of the radio signal comprises a change in signal strength.

The exception condition associated with the unit comprises presence or absence of a predetermined indicator in the radio signal.

Each unit is configured to repeatedly transmit a radio signal with the predetermined indicator as long as the unit is functioning.

Each unit is configured to transmit a radio signal with the predetermined indicator in response to removal of the unit from an asset.

Monitoring a characteristic of at least one other unit comprises monitoring a characteristic of communication with the unit.

The characteristic of communication with the unit comprises communication connectivity.

Monitoring communication connectivity with the unit comprises monitoring a received radio signal from the unit.

The exception condition associated with the unit comprises loss of previously established communication connectivity.

The communication connectivity comprises connectivity of a link between a monitored unit and at least one other unit in a network among the units.

Monitoring a characteristic of at least one other unit comprises monitoring a location of the unit based on a received signature from the unit.

Monitoring the location of the unit comprises receiving a radio signal from the unit.

Monitoring the location of the unit comprises analyzing the radio signal to determine a predetermined signal characteristic.

The predetermined signal characteristic comprises signal strength.

Monitoring the location of the unit comprises receiving an image of a designated area.

Monitoring the location of the unit further comprises analyzing the image to detect presence of the unit.

The exception condition associated with the unit comprises removal from a designated area.

The exception condition associated with the unit comprises one or more of theft, tampering, disabling, and removal from a designated area.

In another aspect, in general, a method for operating among a plurality of wireless units includes, at each of a plurality of the units: monitoring a characteristic of at least one other unit; detecting an exception condition associated with a monitored unit based on the monitored characteristic; and sending an alert message to a plurality of the units in response to detecting the exception condition.

Aspects can include one or more of the following features.

The alert message is transmitted from a unit that detected the exception condition to a unit that did not detect the exception condition.

The alert message is transmitted over links of a network among the units, and the monitored characteristic comprises a characteristic of a link to the monitored unit.

Each of the plurality of units is configured to monitor a characteristic of at least one other unit.

Each of the plurality of units is monitored by at least one other unit.

Aspects can have one or more of the following advantages.

Wireless protection systems can protect assets from theft and tampering. Assets may include physical inventory, sensing and control devices connected by wireless interfaces, wireless network interfaces and personnel. In this system, wireless protection devices are affixed to or incorporated into individual assets to be protected. When wireless protection devices are removed from a protected area, tampered with, disabled or destroyed, the system takes appropriate action, such as raising an alert.

Applications of such a system include inventory management, theft prevention, securing wireless sensing and control networks, perimeter security, network security and personal protection.

A system to prevent theft and tampering uses a network of wireless protection devices (WPDs) that forms a “distributed interrogator” in which each WPD serves as an interrogator for monitoring one or more neighboring WPDs. Consequently, if any WPDs are destroyed, disabled, shielded from neighboring WPDs, or removed from the protected area, the remaining WPDs can raise an alert since at least one WPD will have been interrogating any given WPD. The alert can be transmitted as a message to other WPDs including WPDs that were not monitoring the given WPD. This essentially creates a fail-safe protection system, since disabling the system requires an attacker to disable not only a targeted set of WPDs but also all of the WPDs interrogating the WPDs being disabled (potentially all of the WPDs in the system) before any one of them can raise an alert.

A WPD monitors wireless communication signals from other WPDs in the network to detect when communication links are established or lost. The WPDs measure “Link State”—the set of WPDs that have established links with a particular WPD—and the system responds to changes in Link State. Link State is sometimes used for making decisions in communication networks. For example, networking and routing algorithms monitor changes in Link State to dynamically choose communication paths in networks. In the context of a wireless protection system, Link State and changes to Link State are used to detect, for example, the arrival of, departure of, failure of or disruption to WPDs.

Other features and advantages of the invention are apparent from the following description, and from the claims.

### DESCRIPTION OF DRAWINGS

FIG. 1 is a block diagram of a wireless protection device.

FIG. 2 is a diagram showing wireless connectivity and link state.

FIG. 3 is a diagram of WPDs forming a wireless network and connected to an external network.

FIG. 4 is a diagram illustrating Extending wireless range by adding more WPDs.

### DESCRIPTION

1 Overview

In a wireless protection network, WPDs are nodes in the network that are configured to generate wireless signals and to detect wireless signals from other WPDs. A wireless signal is information transmitted over a wireless medium including electromagnetic signals (e.g., radio signals, optical signals such as light from a source or reflected ambient light, magnetic signals, or electrostatic signals), or acoustical signals (e.g., audible or ultrasonic waves). A link is a wireless communication path between two WPDs. The WPDs may also optionally be connected to each other and/or external networks via a wired medium.

The WPDs are configured to detect a “signature” in the form of a wireless signal that indicates the presence of, and in some cases uniquely identifies, the sender of the signal. For example, a signature can be predetermined information encoded onto a radio signal. A signature can be an image captured by a video surveillance camera. For example, a first camera can have a number printed on it that provides a “signature” in that a second camera can identify the first camera by capturing an image of the number on the first camera. Connectivity of a link is based on whether a signature can be sent and received over the communication path.

A first WPD is a “receiver” of a second WPD if the first WPD, under ordinary circumstances, is able to detect wireless signals (including signatures) sent by the second WPD. A first WPD is a “buddy” of a second WPD if the first WPD is configured to monitor the signatures sent by the second WPD and the second WPD is configured to monitor the signatures sent by the first WPD.

In some implementations, a wireless protection network can be described as a mesh network of WPD nodes. The set M+ representing the mesh network can be defined in terms of a set M that is defined as the set of nodes {n1, n2, n3 . . . } that are buddies with node n0. The mesh network M+ is the transitive closure of M, that is, all nodes that can be reached by traversing links that ultimately connect to n0.

In some implementations, buddies monitor one another and raise alerts (e.g., sending an alert message) on detecting changes. Two or more nodes form a “community of buddies” linked by wireless signals (e.g., radio, optical, or sonic). Each node repeatedly generates a wireless signal with a signature that is monitored by its buddies. The frequency of repetition is application specific. For example, for some applications, a node may generate a signal with a signature once every second. In other applications, less frequent transmission of signatures, such as once every hour, is sufficient. In an optical system, such as cameras receiving video images containing a signature, the sender may be continuously sending the wireless signal, and the receiver repeatedly detects the signature from the wireless signal (e.g., from a video image). The buddies are configured to generate an alert to signal an exception condition upon detecting one or more exception conditions, such as the following examples of exception conditions. The alert messages can be propagated throughout the network so that nodes that did not directly detect the exception condition can respond appropriately.

In a first exception condition, a buddy stops detecting a signature. This can occur if the sending node is removed from the premises, if the wireless signal is blocked in some way, if the sending node is deactivated or fails for some reason.

In a second exception condition, a buddy detects a change in the nature of the signature. For example, if the signature changes in amplitude or phase, it can mean that the sending node is moving. In an optical system (e.g., cameras monitoring cameras), a change in origin of an image can mean that the sending node is moving.

In a third exception condition, a buddy detects a change in the content of the signature. For example, the node may contain a motion detector and will modify its signature to indicate whether the node is moving or not. A node that uses electromagnetic communication could modify the payload of its signature. A node that uses optical communication (such as cameras monitoring cameras) could illuminate a light, or use some visually detectable means to signal the change in state through a change in the content of the signature.

In a fourth exception condition, a buddy starts to detect a signature that was previously undetected. This would happen, for example, when a new node is introduced into the community, or is activated.

In some implementations, buddies use mesh networking to communicate alerts and other information. For example, the same wireless communication medium used to provide the signature can be used to form a mesh network for communicating from, to, and among the nodes in the network (e.g., using peer-to-peer communication). One use of this mesh network is to provide a path for alerts to be propagated through the network and to a gateway or network bridge. However, the mesh network can be used for communicating other information as well.

The same communication links used for sending signatures can be used to form a mesh network in order to propagate information beyond a single node. The mesh network may be used in several ways. The mesh network can be used to propagate alerts to a node or set of nodes in the network, for example, to indicate that a signature is no longer detected or that a previously undetected signature is now detected. Alerts can be sent to nodes in the network that are not immediate receivers of the node generating the alert, or out of the mesh network through nodes that form gateways or bridges to external networks. The mesh network can be used to propagate alerts indicating changes in the nature and/or content of signatures to a node or set of nodes in the network. The mesh network can be used to propagate other information generated by nodes to a node or set of nodes in the network. The same communication links that propagate signatures and alerts can be used to form a mesh network in order to control and query individual nodes in the network. For example, a controlling node (or a node connected to a gateway) can instruct a node in the mesh network to report its current known buddies.

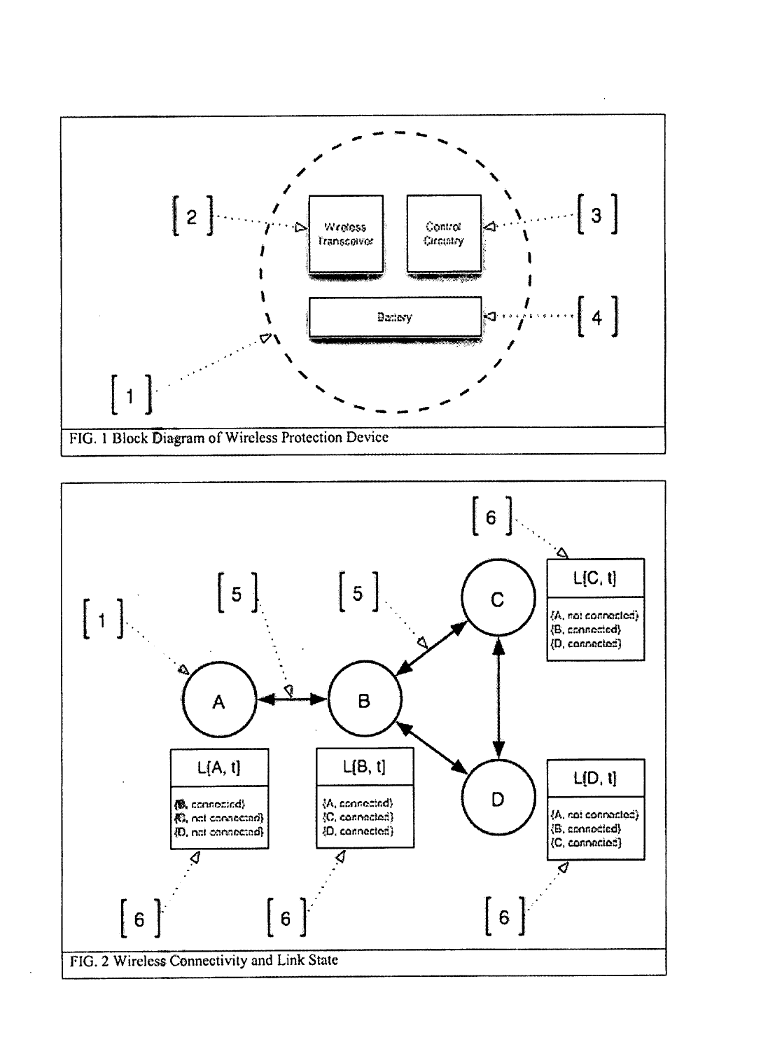

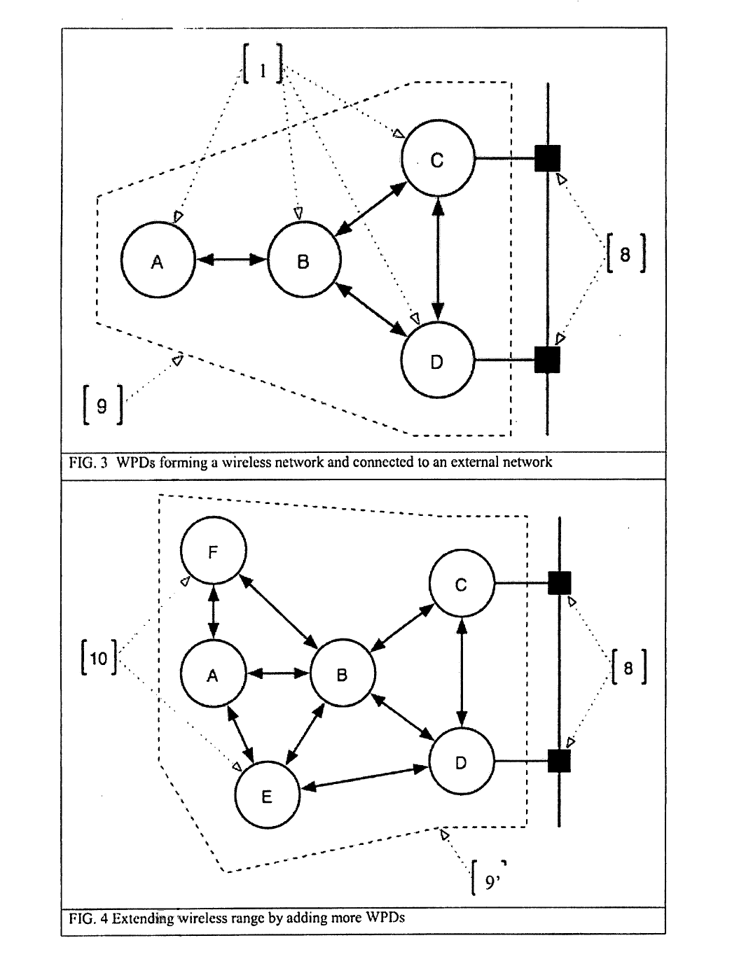

Referring to FIGS. 1-3, in one implementation, a system for wireless protection includes the following:

Multiple Wireless Protection Devices (WPDs) 1 distributed around the area to be protected 9. Each WPD 1 has a wireless transceiver 2 and associated control circuitry 3. Exemplary WPDs are described in more detail in section 1.1 below.

Links 5, whose connectivity is monitored using a record 6 of the Link State associated with each WPD, connecting the WPDs. The Link State comprises the set of transmitting WPDs that are within communication range of a given receiving WPD. An exemplary Link State record 6 is described in greater detail in section 1.2 below.

A control program to be run in each of the WPDs. This program controls when the WPD transmits a message over a link 5 and how to manage the reception of messages. The program may also manage communication with an external network 8 coupled to one or more of the WPDs. An exemplary control program is described in greater detail in section 1.3 below.

A set of Policies that describe what action should be taken upon an exception condition determined, for example, by a change of state at any WPD. An example Policy would be to sound an audible alarm if examination of Link States shows that a transmitting WPD has moved out of wireless range of a receiving WPD. Policies may consider factors other than just Link State, and are described in greater detail in section 1.4 below.

The general approach provides for considerable flexibility of implementation. For example, the record of Link State may be kept locally on a receiving device, or if a network link is available, may be stored and processed on a remote device. The Policies that determine what is considered an exception condition may be implemented on the receiving device, or if the receiving device has a network link, may be implemented on a remote device. These and other extensions are considered in section 2 below.

1.1 Wireless Protection Devices

A Wireless Protection Device (WPD) that uses radio links contains a wireless transceiver and control circuitry to implement algorithms that govern operation of the system.

From time to time the WPD sends a signature message on its wireless transmitter. Under normal conditions, this message is detected by other WPDs within wireless communication range of transmitting device. The messages received by each WPD are used to define the Link State of the system. Exceptional changes in the Link State—for example the appearance or disappearance of a WPD—result in the system raising an alert.

A signature message transmitted by the WPD in some cases includes an identifier that uniquely identifies the transmitting device to any receiving device that successfully decodes the transmitted message. For purposes of asset protection and tamper-prevention, there are circumstances where the identity of the transmitting device is not important, so the identifier may not be present in the signature message. For example, if a receiving WPD stops receiving all transmissions, the system may conclude that the receiving WPD itself has been compromised and raise an alert.

1.1.1 WPDs May be Powered by Batteries or External Sources

The WPD may contain a built-in power source, such as a battery 4. In other cases, power to the WPD may be provided from other sources, including:

power available from the physical asset to which the WPD is attached.

power available from a wired network connection, such as a serial cable or Ethernet connection.

Power harvested from environmental sources, including vibration, heat differential, light, and incidental radiation.

Power derived from intentional radiation.

To expand on this last point, a WPD may be powered by intentional wireless energy, such as provided from a wireless interrogator. This can give the WPD enough energy to power up, do some processing, and communicate the results, if any, over a wired or wireless channel. In a variation on this, the signal generated by the wireless interrogator may contain a message that can be decoded by the WPD. As before, the WPD can use this energy to power up and do some processing, but the action taken by the WPD may be a function of the contents of the message transmitted by the interrogator.

1.1.2 WPDs May have Communication Interfaces to Other Devices

The WPD may contain wired or wireless communication interfaces, such as:

Serial cable

Wired Local Area Network connection (LAN)

Wired Telephone line

Wireless Pager network

Wireless Local Area Network connection (WLAN)

Cellular Telephone network

Satellite link

As described above, in some cases, the wireless transceivers in WPDs are used as elements of a communication network for transmitting information in addition to the signature messages. The transceivers may be used to form a network among the WPDs and other devices, using point to point, star, tree, mesh or other network topologies.

1.1.3 WPD Wireless Links May be Transmit-Only or Receive-Only

In some implementations of the system, it may be economically advantageous to create WPDs that omit the receiver (resulting in a transmit-only device) or the transmitter (resulting in a receive-only device). A practical asset protection system could use a mix of transmit-only and receive-only devices. In such a system, a receive-only device would monitor signatures from a transmit-only device.

1.1.4 WPDs May be Incorporated into Sensing and Control Devices

A basic WPD contains a wireless transceiver, and may contain a communication interface to other devices. In some implementations, WPDs are incorporated into devices with additional sensor inputs and control outputs.

Sensor inputs may include user-actuated buttons, temperature and other environmental measurements, GPS, tilt and motion sensors, magnetometers, analog and digital input ports. Control outputs may include lights, audible alerts, analog and digital output ports.

WPDs may be built into devices in which the primary function is a sensing or control device (e.g., motion sensing for perimeter detection), but which include the circuitry and control logic to implement the wireless protection system.

1.1.5 WPDs May be Incorporated into Wireless Network Devices

In some applications, the functionality of a WPD may be built into a Wireless Network device, such as a Wireless Local Area Network (WLAN) Access Point or WLAN Network Adapter.

These systems can use the wireless communication interface of the WLAN devices to send and receive messages used to implement the protection approach.

1.1.6 WPDs May be Designed to Detect and Resist Tampering

WPDs may be designed with tamper-sensing features. Some actions that a WPD can take upon detecting tampering include:

Transmit an alert message to neighboring WPDs that indicates that tampering has been detected. The neighboring WPDs can take whatever action is appropriate.

Shut down immediately. A WPD may elect to render itself inoperable when it detects tampering. Under normal circumstances, neighboring WPDs will notice that the WPD has stopped transmitting messages and take appropriate action.

Sound an alert.

For physical Asset Protection, it may be especially important to detect when a WPD has been removed from the asset it is designed to protect. Several schemes are described here that can detect this type of tampering:

A mechanical switch on the underside of the WPD is activated by contact with the Asset. If the WPD is removed from the asset, the switch becomes de-activated, signaling the WPD that it has been removed from the Asset.

A capacitive or magnetic proximity sensor in the WPD detects the presence of the Asset. If the WPD is removed from the Asset, proximity is lost, signaling the WPD that it has been removed from the Asset.

An electrically conductive path incorporated into or attached to the surface of the Asset, such as exposed metal on the case of the Asset or a wire glued or welded on the Asset, connects between two or more contacts on the WPD. If the WPD is removed from the Asset, continuity is lost, signaling the WPD that it has been removed from the Asset.

A photocell on the bottom of the WPD is normally in contact with the surface of the Asset, thus perfecting any light from reaching the photocell. If the WPD is removed from the Asset, light can enter the photocell, signaling the WPD that it has been removed from the Asset.

Contacts on the WPD are prevented from forming a connection by an insulator physically connected to the Asset, such as an insulating strip. If the WPD is removed from the Asset, the contacts form a connection, signaling the WPD that it has been removed from the Asset.

If the Asset does not move under ordinary circumstances, the WPD may incorporate a motion sensor. If the motion sensor detects that the WPD has moved, or has assumed an attitude not expected of the Asset (e.g., upside down), this is a signal to the WPD that it has been removed from the Asset.

1.2 Link State and Connection State Define which WPDs can Communicate with Each Other

Link State can be characterized by a measure of connectivity from all possible transmitters in the system to a given receiver. In a system with n transmitters, the link state for receiver r at time t can be written as:
L[r,t]={x₁,q₁},{x₂,q₂},{x₃,q₃}, . . . {xₙ,qₙ}
where each duple {xᵢ, qᵢ} represents the quality of the wireless communication link qᵢ from transmitting device xᵢ. In a simple system, qᵢ may assume the values “connected” and “not connected”. In other systems, qᵢ may encode additional information about the quality of the wireless link or distance between a transmitter and a receiver.

The Connection State of the system is the set of Link States of all the wireless receivers in the system. For a system of n receivers, this is notated as:
C[t]=L[r₁,t],L[r₂,t],L[r₃,t], . . . L[rₙ,t]

The record 6 of Link State at any given WPD includes the Link State L[r, t] for that WPD in its role as receiver r. In some cases, the record 6 also includes Link State information received from any number of other WPDs, and in some cases, the entire Connection State of the system. In some cases, the record 6 of link state is characterized by partial connectivity information that does not necessarily include connectivity between all possible transmitters and receivers, but may include at least local connectivity between a given WPD and other WPDs within a local neighborhood.

1.3 A Control Program Executes in Each WPD

Each WPD includes control circuitry, for example that runs a control program, typically implemented as a set of instructions on a microcontroller, embedded processor or dedicated circuit. The control program may be conceptually divided into three tasks: the Transmit Task, the Receive Task, and the Policy & Action Task.

1.3.1 The Transmit Task

The transmit task is responsible for transmitting wireless signatures from the WPD so that other devices in the vicinity stay informed of the presence of the transmitting WPD. In some implementations, the transmitted signature is a message that includes an identifier such that receiving devices can uniquely identify the transmitting WPD, but there may be instances in which a unique identifier isn't required.

In some implementations, the transmitted message includes a sequence number that changes with each message so that receiving devices can detect missing messages by looking for gaps in the sequence numbers.

The transmitted message may also include additional information, such as time stamps, transmitter power, the Link State and other information available at the transmitting WPD.

The transmit task can employ several strategies for timing the sending of messages used as signatures. Some of these strategies include:

Transmit at regular intervals.

Attempt transmission at regular intervals, but use Carrier Sense Medium Access/Collision Avoidance (CSMA/CA) techniques if the transmitter detects that the wireless medium is in use.

Transmit at random intervals, with or without CSMA/CA techniques.

Transmit a message upon receiving a request over the wireless channel.

Transmit a message upon a signal from another input, such as the push of a button or a request arriving on a communication link.

In the case where the WPD is incorporated into a device that transmits wireless messages according to the needs of the device application, the WPD's messages may be transmitted “incidentally” as a result of the device application.

The transmit strategy may be modified depending on the overall state of the transmitting WPD. For example, a WPD may transmit messages once every ten seconds under normal circumstances. If the WPD can read the state of a physically attached motion sensor, it may choose to start sending messages once every second if motion is detected.

Similarly, if a WPD can read the output of an attached photocell, it may choose to send messages upon request as long as the ambient light levels are constant. If the light levels start to change, the WPD may start transmitting messages proactively.

1.3.2 The Receive Task

The Receive Task is responsible for receiving signatures, such as messages transmitted from other WPDs, and updating the Link State for the receiving WPD.

In addition to capturing any information included in the message by the transmitting device, the receive task may record other available information for purposes of updating the Link State. This other information may include:

Strength of the received signal.

Ambient noise on the wireless communication channel.

Time of the received message.

Distance between the transmitting device and receiving device.

The Receive Task uses this information to update the Link State for the receiving WPD. In some systems, the Link State is maintained on the WPD itself. On other systems, for example, in which the receiving WPD has a network connection to external devices, some or all of the Link State may be sent to external devices for storage and processing.

1.3.3 The Policy & Action Task

The Policy & Action Task is responsible for processing available state information, including Link State from one or more WPDs and any other relevant state information known to the system and taking appropriate actions.

In the case that a WPD lacks any network connection, the Policy & Action Task considers all of the state information available at the WPD and takes appropriate action.

In the case that a WPD has a network connection and Policy processing is implemented on an external device, the Policy & Action task on the WPD only needs to send relevant state information over the network to the external device.

1.4 Policies Map Network State into Actions

A Policy is a set of rules that dictate what actions are to be taken when certain conditions exist in the WPDs and the rest of the system.

A simple Policy might be “If the system detects that a WPD becomes unreachable to all other WPDs (from which the WPD was previously reachable), then send a text message to the store manager.”

A slightly more involved Policy might be “If a WPD previously in the protected area of the warehouse is no longer reachable in the protected area of the warehouse and has been observed by WPDs near the back door of the warehouse, then lock the rear door.”

A Policy may consider other factors besides Link States. For example, a policy might read “If the system detects that a WPD becomes unreachable to all other WPDs in the warehouse, and the time is between the hours of 5 pm and 8 am, then call the police.”

Note that the Policy and Action Task need not be fixed in its actions. The conditions that are considered “exception conditions” may change according to local and global state, and the Policies and Actions may be responsive to these changes.

2 Extensions and Variations to the System

2.1 Additional Devices May be Deployed to Extend Coverage

In some environments, it may be desirable to extend the protected area beyond the wireless range of any WPDs associated with protected assets. For example, protected inventory may be stored at one end of a large warehouse, but it is desired to have coverage throughout the warehouse.

In such cases, as shown in FIG. 4, additional WPDs 10 may be distributed in an expanded protected area 9′ to provide the necessary coverage.

2.2 A Hybrid Active/Passive RFID System

One advantage of a passive RFID (Radio Frequency IDentification) tag is that it doesn't require a built-in power source: its power is provided by the RFID interrogator. One disadvantage of a passive RFID tag is that it must pass by an RFID interrogator to be detected, so if the tag is removed from the asset it is designed to protect, the removal goes unnoticed.

An asset protection device can be built using a WPD which is normally in an unpowered state. The WPD can be constructed so removing it from an asset applies power to the WPD. This can be done with a mechanical arrangement that energizes a battery when the WPD is physically separated from the asset, or it can be done using a piezoelectric device that generates power from the physical force of separating the WPD from the asset. In this case, the WPD needs only enough power to send a message and be detected by neighboring WPDs.

The same WPD can be constructed to power up when interrogated by an RFID reader.

2.3 Reading a WPD with an RFID Reader

A WPD can be constructed to respond to an RFID reader, whether or not it derives its power from the RFID reader's interrogation signal. This can be done in several different ways:

The WPD responds to the RFID reader with wireless signals that are detected by the RFID reader as if they were generated by a passive RFID tag.

A passive RFID tag is co-located with the WPD and responds to the RFID reader as a conventional tag.

Upon detecting the presence of an RFID reader's interrogation signal, the WPD communicates its identity and other related information over a separate network channel. The read event is detected elsewhere in the system, and not necessarily at the RFID reader.

2.4 Network Security

The wireless protection system can use techniques for detecting when a device unexpectedly leaves a wireless network, when a device enters an unauthorized area of a wireless network, or when an unauthorized device enters into an area protected by the network.

The system may also be protected from unauthorized devices which mimic the behavior of authorized devices. For this, any of a variety of security schemes may be employed. Devices in a network may share a common security key and encryption system, and use encrypted communication to exchange information. Only messages that are properly encrypted by the shared key are recognized; other messages may be assumed to originate with unauthorized devices.

Other authentication and security schemes are possible. A WPD may maintain an “access list” of WPDs that it will recognize, and treat other devices as unauthorized devices.

Unrecognized or un-trusted devices may be admitted to a system if they properly respond to a “challenge question”, using built-in keys or keys accessed from a trusted “third-party”.

3 Example Implementations

3.1 Example Implementation: Theft Prevention Tags

Wireless Protection Devices can serve the function of Anti-Theft devices for merchandise. Each WPD is equipped with a battery, an audible alarm and a tamper-proof mechanism that deactivates the wireless transceiver if it is physically removed from the merchandise. Specialized WPDs serve as gateways to an external network, such as a corporate LAN.

In this implementation, the WPDs use their wireless transceivers not only for monitoring Link State, but also for communicating alert messages that signal exception conditions to the gateway devices using multi-hop or mesh routing techniques.

One policy for this implementation might be to raise an alert on the external network if any previously observed WPD becomes inaccessible to all other WPDs in the system, since it would indicate that the WPD had been removed, disabled or destroyed.

Another policy for this implementation might be to sound the audible alarm on a WPD if reception of all signals stop, since it would indicate that the WPD itself was cut off from its neighbors, either by being removed from the protected area, put into a “booster bag” or having its wireless communication intentionally disabled through some other means.

3.2 Example Implementation: WLAN Protection

The approach may be embodied in the hardware and firmware of a Wireless Local Area Network (WLAN) IEEE 802.11 Access Point or Adaptor which have been enhanced to run the algorithms described in this description. In this mode, the system is not designed to protect physical assets, but rather to preventing tampering and unauthorized intrusion into the wireless network itself.

As with other implementations described above, the WPDs send messages that make the WPDs known to their neighbors, but in this case, the messages are “incidental” messages, sent as part of the communication protocol for IEEE 802.11. Other Access Points and Adaptors in the system will update their Link State according to received messages.

One possible policy is to signal an exception condition using the corporate wired network when an Access Point goes out of range or disappears from the Link State of the other WLAN devices, since this could indicate that an Access Point had been stolen or damaged.

Another possible Policy is to signal an exception condition when an unrecognized or unauthorized Access Point or Adaptor appears in the Link State of existing WLAN devices, since this could indicate the intrusion of a “rogue” device.

3.3 Example Implementation: Perimeter Security

The approach may be used as part of a system to secure a perimeter. An effective perimeter security system detects intrusion, and detects if an intrusion sensor has been disabled.

As an example, a system of intrusion sensors may be placed around the perimeter of an area to be protected. The intrusion sensors may incorporate audio and seismic sensors, video and light sensors, magnetometers and other techniques for detecting an intruder.

WPDs are incorporated into the intrusion sensing devices.

The wireless communication links used by the WPDs serve double duty: they define the Link State among the WPDs, and they form a communication mesh to relay intrusion information to one or more network gateways and/or sentry devices.

If an intruder is detected, the wireless network relays the information to the gateways and/or security devices.

Similarly, if an intrusion sensor is disabled or physically removed from the protected area, the system sends a notification indicating that the network has been compromised.

3.4 Example Implementation: Securing industrial Processes

Wireless sensing and control networks in industrial applications require careful treatment: a loss of communication with a sensor or actuator can result in the failure of an entire manufacturing line, or injury or loss of life to personnel.

In applications where sensing and control devices are linked wirelessly, the approach can be incorporated into the communication subsystems for the sensors and controllers. In a single unit, various techniques can be used to determine if the sensor or controller is operating properly, and the wireless protection system can assure that the communication link to the sensor or controller is functional. In case the communication link becomes non-functional, the manufacturing process can be stopped in an orderly way, or other appropriate action taken.

3.5 Example Implementation: Human Safety Net

A system of WPDs may be used as part of a personnel security system for military, emergency or domestic applications. Each person in within a group (e.g., platoon or family) may carry a WPD.

The wireless links of the WPDs are used to form a communication network. If one or more members of the group goes out of wireless range of the other WPDs, an alert is raised using the remaining WPDs. By the same mechanism, if a WPD is cut off from other WPDs (e.g., if an individual is cut off from the rest of the group), the WPD can raise a local alert.

The wireless links formed by the collection of WPDs may also be used as a communication network for other purposes. For example, each WPD may contain additional sensors, such as motion sensors, temperature sensors, etc. If any of the sensors indicate an abnormal state (“I've fallen over”), the network can be used to raise an alert.

It is to be understood that the foregoing description is intended to illustrate and not to limit the scope of the invention, which is defined by the scope of the appended claims. Other embodiments are within the scope of the following claims.

What is claimed is:

1. A wireless protection system comprising:
a plurality of wireless units;
wherein each of a plurality of the units are configured to monitor a characteristic of at least one other unit, to detect an exception condition associated with a monitored unit based on the monitored characteristic, and to send an alert message to a plurality of the units in response to detecting the exception condition.

2. The system of claim 1 wherein the alert message is transmitted from a unit that detected the exception condition to a unit that did not detect the exception condition.

3. The system of claim 1 wherein the alert message is transmitted over links of a network among the units, and the monitored characteristic comprises a characteristic of a link to the monitored unit.

4. The system of claim 1 wherein each of the plurality of units is configured to monitor a characteristic of at least one other unit.

5. The system of claim 1 wherein each of the plurality of units is monitored by at least one other unit.

6. The system of claim 1 wherein monitoring a characteristic of at least one other unit comprises receiving a radio signal from the unit.

7. The system of claim 6 wherein the exception condition associated with the unit comprises a change in the nature of a signature of the radio signal.

8. The system of claim 7 wherein the change in the nature of the radio signal comprises a change in signal strength.

9. The system of claim 6 wherein the exception condition associated with the unit comprises presence or absence of a predetermined indicator in the radio signal.

10. The system of claim 9 wherein each unit is configured to repeatedly transmit a radio signal with the predetermined indicator as long as the unit is functioning.

11. The system of claim 9 wherein each unit is configured to transmit a radio signal with the predetermined indicator in response to removal of the unit from an asset.

12. The system of claim 1 wherein monitoring a characteristic of at least one other unit comprises monitoring a characteristic of communication with the unit.

13. The system of claim 12 wherein the characteristic of communication with the unit comprises communication connectivity.

14. The system of claim 13 wherein monitoring communication connectivity with the unit comprises monitoring a received radio signal from the unit.

15. The system of claim 13 wherein the exception condition associated with the unit comprises loss of previously established communication connectivity.

16. The system of claim 13 wherein the communication connectivity comprises connectivity of a link between a monitored unit and at least one other unit in a network among the units.

17. The system of claim 1 wherein monitoring a characteristic of at least one other unit comprises monitoring a location of the unit based on a received signature from the unit.

18. The system of claim 17 wherein monitoring the location of the unit comprises receiving a radio signal from the unit.

19. The system of claim 18 wherein monitoring the location of the unit comprises analyzing the radio signal to determine a predetermined signal characteristic.

20. The system of claim 19 wherein the predetermined signal characteristic comprises signal strength.

21. The system of claim 17 wherein monitoring the location of the unit comprises receiving an image of a designated area.

22. The system of claim 21 wherein monitoring the location of the unit further comprises analyzing the image to detect presence of the unit.

23. The system of claim 17 wherein the exception condition associated with the unit comprises removal from a designated area.

24. The system of claim 1 wherein the exception condition associated with the unit comprises one or more of theft, tampering, disabling, and removal from a designated area.

25. A method for operating among a plurality of wireless units, comprising:
at each of a plurality of the units,
monitoring a characteristic of at least one other unit;
detecting an exception condition associated with a monitored unit based on the monitored characteristic; and
sending an alert message to a plurality of the units in response to detecting the exception condition.

26. The method of claim 25 wherein the alert message is transmitted from a unit that detected the exception condition to a unit that did not detect the exception condition.

27. The method of claim 25 wherein the alert message is transmitted over links of a network among the units, and the monitored characteristic comprises a characteristic of a link to the monitored unit.

28. The method of claim 25 wherein each of the plurality of units is configured to monitor a characteristic of at least one other unit.

29. The method of claim 25 wherein each of the plurality of units is monitored by at least one other unit.
